(19) United States
(12) Patent Application Publication
(10) Pub. No.: US 2013/0244218 A1
(43) Pub. Date: Sep. 19, 2013

(54) EDUCATIONAL SYSTEM EMPLOYING VIRTUAL ENVIRONMENTS

(71) Applicants: Dale L. Cook, Akron, OH (US); Stephen M. Zapytowski, Kent, OH (US); Annette L. Kratcoski, Kent, OH (US)

(72) Inventors: Dale L. Cook, Akron, OH (US); Stephen M. Zapytowski, Kent, OH (US); Annette L. Kratcoski, Kent, OH (US)

(21) Appl. No.: 13/419,501

(22) Filed: Mar. 14, 2012

(51) Int. Cl. G09B 3/00

(52) U.S. Cl. 434/350

(57) ABSTRACT

An educational system consists of developing a virtual environment accessible by students and teachers through video game-like experiences. Each of the teachers and students is assigned an avatar that is uniquely controlled by the associated student or teacher. The students manipulate their avatars within the virtual environment, resolving issues, solving problems, and learning along the way. Each student has a student portfolio indicating the student's progress and deficiencies as assessed by the student's activities through the avatar in the virtual environment. A virtual learning core communicates with remote educational organizations having virtual environments and is in selective communication with each. The virtual learning core includes a database for receiving, storing, assessing and transferring data and student and teacher interface modules in interconnection with the database to allow communication among students and with a teacher within the virtual environments.

### TECHNICAL FIELD

The invention herein resides in the art of educational systems and, more particularly, to educational systems of the distance learning type. Specifically, the invention relates to an interactive system accommodating a host of participants and employing virtual environments tailored and self-evolving for specific learning experiences.

### BACKGROUND ART

Over the years, techniques for educating individuals have evolved from self education and parent teaching to small classrooms accommodating multiple grades and disciplines. The evolution continued to more focused and concentrated classrooms of singular grades and discipline. All of these educational techniques typically required the physical presence of a teacher/professor and students in a bricks and mortar classroom. Such arrangements accommodated personal interaction between and among the teachers and students. Indeed, at this point, classroom size was a concern to ensure the ability for such personal interaction.

As educational costs per student rose, education turned to classes that were conducted by broadcast from one teacher/professor location to multiple classrooms equipped with receivers tuned to the broadcast. This gave rise to a loss of normal classroom interaction previously enjoyed by teachers and students, a loss of feedback and cross talk, and a loss of the face to face interaction between teachers and students. The evolution has continued, however, to a point where “distance learning” now accommodates the presence of a teacher or professor at one location or campus while presenting simultaneously to students at various remote campuses. Further, web-based classes are now provided without an instructor present at all. Such an arrangement has further aggravated the loss of personal relationships, feedback and interaction. While costs are abated, there is concern that the quality of education may be diminished by such activities.

It is well known that a large portion of the student population occupies itself today with “video games” of a wide variety of natures and types, finding those games more enjoyable, satisfying and rewarding than typical learning experiences—whether self-study, in a classroom, or in a remote distance learning environment. Indeed, homework and education in general often take a backseat to video games and particularly those of an interactive nature.

There is a need in the art for an educational system that capitalizes on the enthusiasm of students with video games and one that can convert a “game” into a learning experience. There is a need for such an educational system that is adaptable to use with an unlimited range of virtual environments as a background for learning experiences. There is an additional need in the art for an educational venue that is attractive to students, while being cost effective in implementation. A further need exists for an educational system that is interactive among the students and faculty, and which allows access by parents, and which is “user friendly” for all involved, and which accommodates implementation with state of the art technology. Indeed, there is a need in the art for an educational system as just stated that itself evolves as new teaching techniques, programs, games, learning modules, and tools are developed by its various users.

### DISCLOSURE OF INVENTION

It is a first aspect of an embodiment of the invention to provide an educational system employing virtual environments in the format of video games with a host of virtual environments.

Another aspect of an embodiment of the invention is the provision of an educational system employing virtual environments that capitalizes on the enthusiasm of students for video games.

Yet another aspect of an embodiment of the invention is the provision of an educational system employing virtual environments that allows the creation of an interactive video game within a virtual environment to provide a learning experience.

Still a further aspect of an embodiment of the invention is the provision of an educational system employing virtual environments that are cost effective in implementation with state of the art technology.

A further aspect of an embodiment of the invention is the provision of an educational system employing virtual environments that is interactive among students, faculty, and parents at various access levels.

Yet another aspect of an embodiment of the invention is the provision of an educational system employing virtual embodiments that accommodates growth, expansion and evolution of the learning process, allowing for the development of environments, tools and techniques that may be employed, modified or enhanced for future use in learning experiences by the users of that virtual embodiment.

Still another aspect of the embodiment of the invention is the provision of an educational system employing virtual environments that closely replicates face-to-face engagements between and among teachers, students and others.

The foregoing and other aspects of embodiments of the invention that will become apparent as the detailed description proceeds are achieved by a method for educating students through the use of virtual environments, comprising: developing a virtual environment adapted for implementation with a course of study and presenting various learning opportunities, said virtual environment being accessible through video game like experience for students; assigning at least one avatar to each of said students, each student exercising control over a uniquely associated avatar, each said student controlling said uniquely associated avatar as to navigation, movement and decision making within said virtual environment; said students resolving issues and solving problems posed in said virtual environment; and each said student maintaining a student portfolio containing input from said student indicating said student's progress and deficiencies as assessed by said student's actions in said steps of resolving issues and solving problems.

Additional aspects of the embodiments of the invention that will become apparent herein are attained by an educational system employing virtual environments, comprising: one or more remote educational organizations, each having associated therewith one or more virtual environments; a Virtual Learning Core in selective communication with each of said one or more remote educational organizations; and wherein said Virtual Learning Core comprises: a database for receiving, storing, assessing and transferring data; an avatar tool in communication with said database for enabling teachers and students to create for themselves uniquely associated avatars for selectively engaging in activities within said virtual environments; and students and teacher interfaces in intercommunication with said database for communication among students and a teacher within said virtual environments.

### DESCRIPTION OF DRAWING

For a complete understanding of the various structure and techniques of embodiments of the invention, reference should be made to the following detailed description and accompanying drawing wherein there is shown a system illustration of the components and participants comprising various embodiments of the educational system of the invention.

### DETAILED DESCRIPTION OF PREFERRED EMBODIMENT

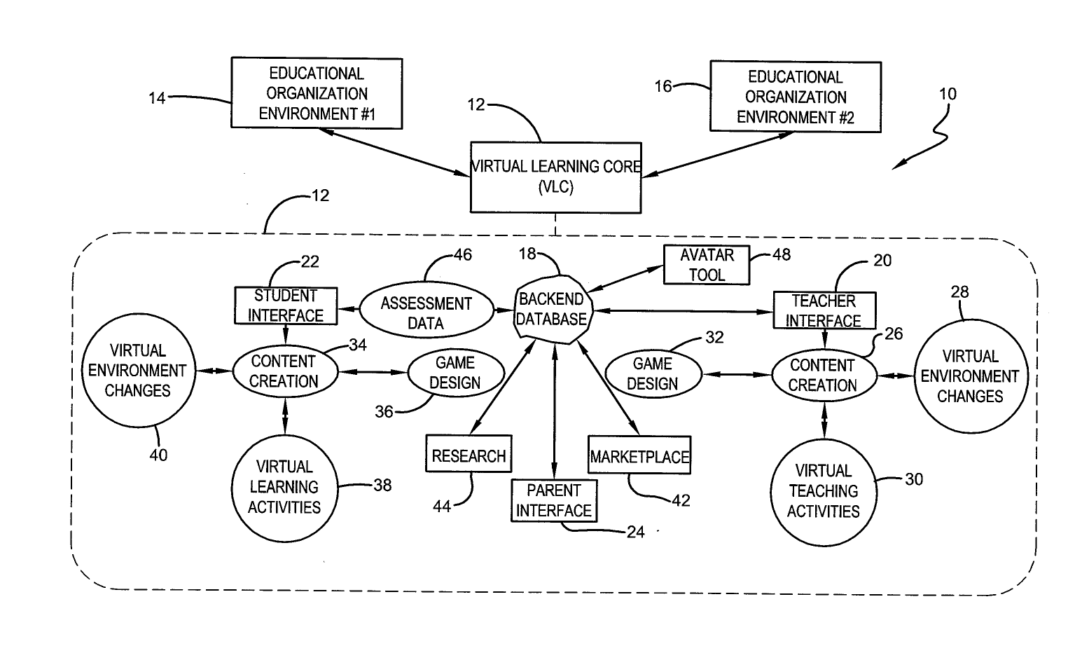

With reference to FIG. 1, an appreciation can be obtained as to the basic structure and constituent elements of the educational system employing virtual environments of the invention, which is designated generally by the numeral 10. As shown, a virtual learning core 12 supports multiple virtual satellite learning environments for teaching and learning, in which teachers and students can connect at any time, whether in-school or out of school. The virtual learning core 12 coordinates use of two-way voice and text communications, enabling teacher-student interaction and student-student interaction, whether in classrooms, from home or other locations beyond a school setting, through the use of computers, hand-held smart devices, and other means of communication. The interactions of the educational system 10 may extend across multiple organizations and school sites, as shown in FIG. 1 where the virtual learning core 12 is in communication with exemplary educational organizations 14 and 16. Those educational organizations may be anything from grade school environments to community agencies, museums, post graduate school labs and clinics. While the concepts of the embodiments of the invention are adaptable for use for any of a wide variety of curriculum, the concept is particularly adapted for STEM (Science, Technology, Engineering and Mathematics) curricula. The framework for virtual learning core 12 is designed and based upon a number of principles regarding teaching and learning, particularly in a STEM environment, in a digital age. It particularly gives attention to the following:

1. Students, teachers and parents are represented in virtual learning environments by avatars, which are selected and customized using an intuitive avatar tool 48 provided by the system operator. Those skilled in the art will appreciate that, in the computer world, an avatar specifically refers to a character that represents an online user. Avatars are commonly used in multiplayer gaming, online communities, and Web forums. Avatars may be adaptive such that, as a player progresses in a game, his character may gain items and experience, which allows the avatar to evolve over time. Avatars can be custom-designed to create a truly unique appearance for each player. Once a user has created an avatar, he or she becomes part of an online community filled with other users' avatars. Players can interact with other avatars and talk to them using text or voice chat. In general, avatars allow people to represent themselves online in whatever way they want. They may be considered alter-egos, since users can customize characters that are completely different than their actual personas.

2. Curricular content designed by both teachers and students is central to learning and critical thinking. The virtual learning core 12 manages the content created by both students and teachers in the learning environment and determines which users can access the content.

3. Recognizing the need for flexible and adaptive learning environments, the system 10 is designed to receive input from teachers and students so that each satellite environment can continue to evolve along with the changing needs of its users. In other words, neither the virtual environment associated with an educational organization 14, 16 is fixed or set, but is of an adaptive nature, given to change in the dynamics of the teaching/learning process.

4. Because learning can be of both a formal and informal nature, the virtual learning core 12 is accessible 24 hours a day, 7 days a week, to teachers, students and parents alike, although access windows for parents are controlled by the teachers. The virtual learning core 12 offers a formal context for teachers to provide instruction as well as opportunities beyond the school day for students to work individually or collaboratively on assignments and projects, to explore environments within the virtual world, to socialize, play games and pursue quests, and/or to engage in game development themselves.

5. Since games are a valuable mechanism for teaching and learning, the virtual learning core 12 is designed to host games within the environments of the satellites 14, 16 that can be user-created, or built by the system operator. Such games provide a context for teaching and learning not only STEM content but also STEM skills and systems thinking, which are essential for preparing individuals for STEM careers. Current research emphasizes how making games fosters the development of critical STEM skills, including systems thinking, problem solving, iterative design and digital media literacy.

6. Because of the importance of authentic and challenging learning experiences, the virtual learning core 12 is designed to manage the experience of students and the satellite environments 14, 16 to experience conditions and locations too difficult, too dangerous, or too expensive to access in real life. Similarly, the virtual learning core 12 also provides simulations in which students can rehearse activities prior to real-world experiences. In other words, with presently available graphics and techniques, real-world environments can be substantially duplicated and replicated at the various educational organizational sites 14, 16, allowing the students to investigate the nature and habits of dangerous animals, or the archeological finds of distant places in a near-real-world environment replicated by the virtual learning core 12, but without leaving their own classroom, bedroom, or kitchen table.

7. Because the teacher is integral to successful implementation of the virtual learning core 12 in formal settings, it provides in-world teacher professional development and support.

Building upon the foregoing principals, the virtual learning core 12 is designed to provide each of the satellites 14, 16 with an environment with the flexible and adaptive tools essential to the success of each learning environment through the incorporation of a backend database 18 that includes a teacher interface 20, student interface 22, resource store or marketplace 42, and access to a variety of learning tools and options. In addition, a third party or parent interface 24 is also provided, allowing the parent to view the work activities of a specific student and/or to communicate with the student's teacher.

As shown in FIG. 1, the virtual learning core 12 includes a backend database 18 that provides a means for managing interactive content and data through the teacher interface 20 and student interface 22, thus allowing for the creation and sharing of customized learning modules, curricular content, assessments, and user-created games.

The teacher interface 20 allows teachers to create and share their own curricular content/learning modules. It also enables teachers to create their own assessments in the teacher interface and utilize the database to track the corresponding student data in a variety of formats, including points, grades, awards, and the like. As teachers add information into the database through the teacher interface, the data is interpreted by smart tools available in the virtual learning core 12, which in turn customizes information presented to the students.

The student interface 22 communicates with the virtual learning core 12, allowing students to complete assignments, collaborate with others on projects, and build games. All of the student work is uploaded and tracked by the backend data base 18. A parent or third party interface 24 is also provided for communication with the backend database 18, allowing a parent, with an appropriate coded access key, to access data relevant to an associated student, to view the student's work efforts, grades, and teacher commentary, and to further access communications, with appropriate coded key access, directly with the teacher.

Associated with the teacher interface 20 is a content creation module 26 in operative communication with a virtual environmental change module 28, virtual teaching activities module 30 and game design module 32. The functions of each of these modules are as the names imply. The module 28 allows a teacher to make changes to the virtual environment of the associated educational organization 14, 16 to accommodate changes in lesson plans, techniques and the like. The module 30 accommodates the teaching activities of the teacher, consistent with the teaching plan necessary to achieve the desired educational goals. The game design module 32 allows for modification of existing games, or the generation of totally new games to achieve the conveyance of the desired lesson or lessons content.

In similar fashion, the student interface 22 includes a content creation module 34 that communicates with a virtual environment change module 40, virtual learning activities module 38 and game design module 36. Again, as their names imply, the modules 36, 40 provide the same capabilities at the student level as the modules 28, 32 do at the teacher level. The virtual learning activities module 38 provides the necessary tools for learning, assessing, and analyzing the virtual teaching activities 30 provided by the teacher through the teacher interface 20.

It is well to note the students may actively engage in environment changes at 40 and game design at 36, it now being understood that the generation of virtual environments and games is an educational tool in and of itself.

The virtual learning core 12 hosts a resource store or marketplace 42 where various teaching/learning modules, games, environments and the like, created by teachers and students, can be stored and shared, whether free of charge or at a cost, with other teachers and students. The originator of the system 10 may contract with an educational organization 14, 16 to determine if what has been developed in their environments stays there, or is deposited in the resource store 42 to be offered to others.

The virtual learning core 12 includes a research module 14 that contains a wide variety of relatively curriculum-free tools, such as a graphing calculator, microscope, telescope, voltage and amp meters, pressure gauges, and the like which are accessible to teachers and students to use at any point in time to assist with learning needs, as the virtual environment and virtual teaching activities and virtual learning activities dictate. Additional tools can be added to the research module 44 to address specific needs as additional educational organizations 14, 16 are added as satellites to the virtual learning core 12. The data collection portion of the virtual learning core 12, along with the expertise of those operating the system 10, enables the undertaking of extensive research into the effectiveness, use and appeal of the virtual learning environments for different purposes and audiences. This is undertaken in the research module 44, as well. Student activities, navigation, projects, game results, and other data can all be collected for analysis. Assessments and questionnaires can be built into the environments at 14, 16 for effortless data collection. The design and development of new environments both reflects the results of earlier research and provides the opportunity to iteratively improve the teaching and learning that takes place within them.

The data assessment module 46 is interposed between the student interface 22 and backend database 18 and incorporates parameters established by the appropriate teachers to automatically provide individual awards to students with “level up” style rewards, such a new Avatar clothing options, more capable smart tools from the research module 44, or access to new areas within the environment of each satellite location 14, 16. These awards can be made based upon test scores, the quality of written reports, extra credit work, and the like. The teacher is notified of the granting of such rewards.

A unique feature of the virtual learning core 12 is that it is customizable in a number of ways by the users of each of the satellite environments 14, 16, thus allowing teachers and students from various locations to utilize the virtual learning core 12 within their own settings and with their own learning tools and curriculum. The operator of the system 10 may use the virtual learning core 12 to create and support custom designed learning environments for community based education organizations and to provide development, full installation, initial and ongoing support for the environments, as needed. The backend database 18 of the virtual learning core 12 can be customized so that the kind of data tracked can vary depending upon the changing needs of the educational organizations employing the same. Another customizable feature is the marketplace 42. As discussed above, this allows teachers and students to house and share projects, content, and learning games they create and to share the same across the network of the system 10. Additionally, the operator of the system 10 may conduct in-world professional development implementing a professional development plan that is co-designed with an associated organization to meet the unique needs of that organization, such as offering them in-world teacher assistance for on-going support as needed.

To fully appreciate the structure and operation of the educational system 10, an understanding should be obtained from operational examples, such as those presented below, with regard to educational organizations 14 and 16.

### Educational Organization 14

Here, the teacher interface 20 may be employed to build a lesson for use either during the day or as homework. The teacher selects an area for a virtual learning environment for use during the lesson, for example—a bog. The students may already know the location of the bog, or the bog may be a previously undisclosed area of the virtual learning environment, in which case the teacher provides access to the bog by the students. The teacher may provide a landmark to assist the students in finding the bog, such actions being handled through the virtual learning core 12.

The students then determine the scope of the assignment, in this case the students are to take some water samples and develop a report on the number of species of microorganisms present in the water. The teacher may then enter the assignment's requirements into a message box (by means of a keyboard or the like) that will be delivered to the students. Assessment parameters may be selected from a menu of parameters applied to the assignment, or the teacher may program his/her own assessment parameters through the teacher interface. The teacher may then upload, through the interface 20, the images and/or video that the students will find in their water samples. In addition, the teacher may add one or two stealth assignments for students to discover while exploring the bog. The teacher interface 20 automatically uploads the needed information into the smart tools of the students. The teacher may then recheck the requirements of the assignment and use the interface 20 to save the new lesson to an inventory of lessons. As the students complete the assignment, the teacher can access the work of the various students and monitor their progress as they add information to their associated student portfolio in the backend database 18. Based upon data collected using the assessment parameters, the backend database will automatically deliver remedial work to the students that has be predefined by the teacher in the lesson plan.

With the lesson plan so developed, a student may, at an appropriate time, log into his/her virtual learning environment and the student's avatar will materialize in the environment, usually at the student's home location. A message pop-up with today's assignment will appear. The student then uses the student interface to fully engage the assignment as established by the teacher.

First, the student travels to the bog and can do so by running, walking, flying, or by teleport. Once at the bog, the student uses an appropriate smart tool to collect water samples and scan them. The student then examines the results and determines if he/she has found normal kinds of organisms in the bog. To make that determination, the student would need to do research on microbes normally found in a bog (stagnant water) and determine if the sample is normal or not. A report should then be written and posted in the student's portfolio where the teacher can evaluate the work.

The student may also make notes that the smart tool presented some other data. The student then needs to determine if there is a need to look at the additional data. The student may have no interest in the additional data since the original assignment is complete. Alternatively, the student may show interest, examine the additional data, and note that it shows an extreme abundance of amphibians, particularly frogs, in the bog. The student notes that there are all kinds of frogs in great abundance in the bog.

The students need to determine what, if anything, they need to do about their findings. They can simply forget about the frogs, add the information to their report in the student portfolio, send a message to the teacher about the frogs and ask why there are so many (which will likely evoke a response that the teacher does not know), or send a message to the teacher about the frogs, indicating that the student wants to find out why there are so many—showing a strong engagement on the student's part.

Assuming that the student has not determined to simply disregard the presence of the frogs, a stealth assignment has been triggered. The teacher may direct that the class be divided into teams, with team leadership assigned on the basis of which students had the most active response to the frogs. In keeping with typical game parlance, team leaders may be rewarded by receipt of appropriate gear, such as an extremely effective pair of bog boots for their avatars to wear. Alternatively, a number of points can be awarded to team leaders, the accumulation of which may be used to advance to another level and gain more substantial in-world rewards. In either event, as the game continues the teams depart for the bog, with individual members of each team working a different portion of the bog and using their smart tools to acquire data such as from (a) conducting a wildlife survey, (b) monitoring air quality and weather conditions, (c) collecting and analyzing soil samples, and (d) checking water samples for contaminants. Each team member posts his/her findings in their respective personal student portfolios. Each team confers about the findings of the various team members and the team leader posts their conclusions.

If the students have been attentive to the virtual environment created, and if they properly used their smart tools in their investigations, a number of conclusions will be drawn, such as (a) all of the blue herons have vanished from the bog, (b) there are no water snakes in or around any of the ponds, (c) there is a suspected imbalance in the microbes collected from the pond, and (d) there are so many frogs because at least some of their predators have vanished from the bog.

Based upon these conclusions, the teacher communicates back to the students or team leaders, requesting that they determine why the blue herons and snakes are gone and if there is something wrong with the water or if the noted imbalance is just a benign anomaly. Thus, another stealth assignment has been triggered by the findings and conclusions resulting from the investigation pertaining to the substantial number of frogs at the bog. The adventure continues.

The game that has engaged the students may trigger in some an idea for the development of a game that would help others learn the concepts that the students just mastered. Some students might team with a friend to collaborate to design a new game, which could be saved to the student's inventory and be made available to others in the marketplace 42.

In addition, the performance of the students at the bog may have earned them enough “experience points” to select some new plug-ins for the smart tools to be used in the future.

The visit to the bog and the lessons learned by the participating students have been achieved in a virtual environment of a bog with the intrigue of a video game. The lessons can be learned without the incident time, expense, and risk associated with a trip to a bog. Indeed, the lesson can be learned even if a bog is not available or in the wintertime when the bog and relevant life forms would be absent or dormant.

### Educational Organization 16

In the virtual environment 16, a different lesson may be taught through game playing along the following lines. In this instance, the educational organization 16 may be interested in a long term, multi-faceted project focused on continual engagement of its students. It may put in place the educational system 10 with virtual learning core 12, containing features and pre-positioned content needed for the class of interest. This may include the raw materials needed to be placed in the virtual learning environment for the students to discover and use. Lessons may be built and saved into inventory for future use and these saved lessons may then be included in the virtual learning core 12 so that they are ready for implementation with a lesson offered at the educational organization 16.

As a new class starts, the teacher may give a homework assignment to the students to have them log into the new virtual learning environment welcome center. In the welcome center, students learn how to move around in the virtual learning environment. There they learn simple things for their avatar, such as walking, navigating, running, jumping, sitting, teleporting, and the like. They also learn the basics of communicating with the remainder of the class using text and voice chat. There is also a basic introduction for the students how to use the student interface 22 and how to post items to their individual student portfolio.

As part of an introductory game, after the initial aspects of the virtual learning environment have been absorbed by the students, they are given their first assignment which is to use the welcome center's telepad to teleport to a major pharmaceutical lab to see a presentation by a famous scientist. Indeed, such presentations may be routine in a virtual learning environment. Here, however, when the student's avatar steps on the telepad and presses the energized button, things become disoriented, the world appears to be spinning, and the avatar gets dizzy. Upon landing, the student realizes that he/she is not in a lab, and the student's avatar is dizzy, incapable of seeing clearly, and uncertain as to where it is.

As things settle down, it becomes clear that the avatar is not in a lab, but in fact there are no buildings around at all. Instead, there are palm trees and a mountain. Indeed, there is a beach but it is uncertain whether the student is on an island or not. A text message pops on the game pad from the teacher, indicating that something has gone terribly wrong with the telepad and that no one arrived at the lab. The educational organization has no idea where the class went or even if the entire class went to the same place. Wherever the class has ended up, there is no way for the educational organization to get them back. Even if they can fix the telepad, the only other one is at the pharmaceutical lab. While text chat remains available with the teacher, voice chat is not working at the moment. The student is advised that he/she needs to find any fellow students, learn where the student is, and get that information back to the educational organization. The teacher requests the development of a plan.

The student begins to notice that other students are materializing at random locations, but not the entire class. The student talks with the other students to determine what information each might have that is different from the others. The students determine that they have various choices, including (a) sitting around and waiting to be found, (b) splitting up and searching the virtual learning environment for other students, (c) setting a rendezvous point to meet at after each person has searched a portion of the virtual learning environment, (d) sending someone to the top of the mountain to see what can be learned from that vantage point, and (e) determining that there are no wrong choices at this point, and registering anxiety as to what to do.

The game can, of course, take any of various turns, but assume that the students split up to search different portions of the virtual learning environment and have returned to the rendezvous point. A student may realize that his/her avatar cannot run anymore and is walking slowly. The student may question whether the avatar is getting dehydrated and whether anyone found any fresh water. It may also be noted that the sun is going down and is getting cold. The issue arises as to whether someone can find a way to start a fire. Among the returning students, it may be noted that someone brought back a bunch of strange looking fruit, but a determination needs to be made as to whether the fruit is safe to eat. Those who went up to the mountain may report to the class that they are on an island and there is no other land in sight. Other students may have seen a huge quantity of blue flowers, but are not certain whether they are safe to eat. One or more students may query whether there is a way to build a net to fish on the water surrounding the island and, if so, how can they determine which fish are safe to eat. One student may report having seen wild pigs, but noting that they are frightfully aggressive. During the accounting period, it is noted that no one saw any buildings or any sign of other people at all. Finally, various of the students noted the presence of lots of coconuts, but they only offer a temporary food solution, do not provide balanced nutrition, and no one can open them.

There may be an extensive list of findings of the various students, but by the sharing of information between and among the various students, the whole class has a wealth of information that may be uploaded into the student portfolios. With this information at hand, and communicated to the teacher, either by the teacher's access to the student portfolios or directly, the teacher may respond that it is unfortunate that they appear to be on an isolated island and the teacher may suggest that the students find a way to build shelters. The teacher may further ask if the students have a plan to survive and if they even know the hemisphere of their location. The teacher may be involved in the development of a plan to the extent necessary, giving the students as much flexibility and adaptability as possible within the confines of the game. Typically, the students will divide various aspects of research to help ensure their survival until rescue. Whether leaders emerge from the group or not, it is clear that a new social structure will need to evolve in order to ensure survival. While only avatars are at risk, people usually develop an attachment to their avatars and view them as a personal extension of themselves. Each student will want his/her avatar to survive.

Research tasks may be divided among different teams that must report their findings to their teacher as well as to the group. Those tasks might include (a) researching the constellations in the night sky to determine whether the students are in the northern or southern hemisphere, (b) learning how to build a fire without tools, including exploring the island to seek out possible materials that can help, (c) researching the types of food that grow on tropical islands and comparing that to the fruit that has been found, determining if the fruit indicates a Pacific or Atlantic ocean island, determining what species of food are safe to eat, what nutrients they provide, and whether the fruit may help you stay alive but ultimately lead to malnutrition, (d) knowing that Polynesians can open coconuts with rocks, researching the technique (e) noting that there are lots of vines on the island, determining whether the bark can be stripped into fibers to weave a net, (f) determining whether the rocks found on the mountain can be of any use, (g) determining whether the blue flowers are edible, what nutrients they provide, and whether there is a source sufficient to sustain the whole class, (h) determining how to hunt the wild pigs, which should provide a good source of protein—the wild pigs may be hunted with snares, nets and spears, but their aggressiveness can give rise to injury.

The desire to hunt or capture the wild pigs for food can give rise to a stealth lesson in the game. A student may be wounded in a calf by a tusk of a bore and, while not a serious wound, the wound becomes inflamed and the infection begins to spread. The students need to determine how to cure the infection. Among themselves, or with the teacher's assistance, they may ask whether anyone noticed any molds on the island that might have antibiotic quality, or for any plants that anyone has seen that might have the same effect. Whatever the findings and determinations, it is clear that the health and safety of the students is paramount and treatments for injury must be given consideration.

As the school term continues, the students continue to post the reports in their student portfolios. The teacher raises more questions and gives advice. Although the students have determined that they are in the Southern hemisphere on a Pacific island, the area of the search is vast, the searches to date have been fruitless, and the teacher reports that the class may never be found. Against, this background, the students discover that they are stripping the island of its resources and are beginning to run out of food. What the students have been eating, including the fish, are not being replenished fast enough to sustain the entire class. The class will need to be responsible for its own rescue. The teacher queries, using only what is available, what can the students make to escape?

In response to the teacher's question, the students note that there are logs on the island from which a raft could be made, but a raft must be paddled constantly or is at the mercy of ocean currents and wind. Accordingly, the students determine that this is not best of ideas. Alternatively, the students consider that outrigger dugout canoes can be fitted with sails and steered. But issues arise. How can a log be hollowed out? Can sails and rigging be made out of palm fronds and vines? A student recalls that ancient Polynesians knew how to do these things—can the students learn how before it is too late? Questions also arise about storing fresh water and food for the voyage. Issues also arise as to determine what direction to sail. A response from another student may indicate that he/she had noticed flocks of birds that flew from the island every day to the northeast and returned to the island to nest in the trees every night. The students may question where they go during the day. They may further question whether the winds favor sailing in that direction.

The students, either on their own or with teacher prompting, then query whether fish nets can be made out of the vines that they had discovered on the island. It is further questioned whether a finer fabric can be woven from the vines and if there is pitch or even possibly a latex rubber available from some of the trees on the island to seal the fabric so made. The students then query, alone or through teacher prompt, the details regarding the rocks found on the mountain. Noting that they are red, indicates that they have a high iron content. With this understanding, one queries whether there is a way to make an acid from what has been found on the island. If the rocks are mixed with the acid, hydrogen can be generated. Finally, the students may query, on their own or with teacher prompts, as to whether it is possible to fly off of the island in a balloon of their making using the sealed fabric and filling it with hydrogen. The balloon ride, however, depends upon which way the winds predominantly blow. Having noted the daily flight of the birds, it is desirable to navigate in the direction of the bird flight where an island or other land with a village on it may be found. Doing so, the class is saved and transported back to the welcome center where the academic term began.

Following the lesson plans of this second example, observation, deductive reasoning, and analysis all play a part in a game where the avatars of the students were saved and knowledge gained. The knowledge is shared among the students who all share the same goal of getting off of the island, and with the teacher as well.

Parents may actively engage in the education of their children/students through the parent interface 24, using an initial password and user name provided with the child's teacher to log into the associated virtual learning environment. Once logged in, the password can be changed and the child's student portfolio can be accessed and reviewed. Here, the parents are able to view their children's work to date, including completed projects, as well as work in progress. Parents are also able to explore the virtual learning environment and visit the same places where their student has been working. Parents may leave comments for their student or the child's teacher, view coming assignments and deadlines, and read the associated class blog.

As an educational organization using the system 10, the organization is able to study the effectiveness, use and appeal of the various virtual learning environments for meeting the goals and required outcomes of the educational organization. Student activities, navigation, projects, game results, and other data can all be collected for analysis. Assessment and questionnaires can be built into the environment for effortless data collection. The resulting data may inform refinement and continued development of the organization's virtual learning environment.

It will be appreciated from the foregoing that the system 10 moves education into the future by accommodating development of immersive virtual environments to more fully engage students and teachers in learning. The virtual learning core 12 may be used to develop high quality, stable, secure customized virtual environments for any of a wide variety of organizations. The virtual learning core 12 supports multiple virtual satellite learning environments for STEM teaching and learning (as well as a host of other educational areas) in which teachers and students can connect at any time from virtually any location. The virtual learning core 12 coordinates use of two-way voice and text, enabling teacher/student interaction and student/student interaction in classrooms, from home and other locations beyond school settings using computers and hand-held smart devices. Interactions may extend across multiple organizations and school sites. The virtual learning core 12 is designed to provide each satellite environment 14, 16 with the flexible and adaptive tools essential to the success of each learning environment through the incorporation of a backend database 18 that has an associated teacher interface 20, student interface 22, parent interface 24, marketplace 42 and access to a variety of learning tools and options at 44.

The virtual learning core 12 is customizable in a number of ways by the users of each of the satellite environments, thus allowing teachers and students from varying locations to utilize the virtual learning core 12 within their own settings and with their own learning goals and curriculum. The virtual learning core 12 may be used to create customized learning environments for community based education organizations, with the backend database 18 being customized so that the kind of data tracked can vary depending upon the changing needs of the user. Another customizable feature is the marketplace 42 where teachers and students may house and share projects, content, and learning games they create and they also opt to share the same across a learning network. Finally, the system 10 can be used to conduct in-world professional development implementing a professional development plan that is co-designed with a user to meet the unique needs of that user and offering an in-world feature assistance for on-going support, as needed.

The system 10 is an open virtual education environment where teachers and students may develop learning modules for use in a completely flexible and multi-use virtual environment. The system employs cutting-edge technologies to create the virtual education environments, such as Unity software, one of the most successful and widely used game engines in the world. It is an exceptionally powerful tool for building virtual environments. Unity has no size limit to the custom internal programming that may be employed within it. Moreover, its physics engine is exceptional. The system 10 has the ability to create extremely accurate and attractive worlds for teachers and students to share. The unique nature of the satellite virtual environments come from linking them to the virtual learning core 12 which takes the students and teachers from a single purpose system to a highly customizable world that will grow and evolve as they use it. Further, Unity allows for the creation of a secure, closed circuit network for each satellite environment with access controlled by each educational organization. An ordinary web browser may be used to access each satellite environment. No special software is required by the students and teachers.

Thus it can be seen that the various aspects of embodiments of the invention have been satisfied by the structure and techniques presented above. While in accordance with the patent statutes only the best known and preferred embodiments of the invention have been presented and described in detail, the invention is not limited thereto or thereby. Accordingly, for an appreciation of the true scope and breadth of the invention reference should be made to the following claims.

What is claimed is:

1. A method for educating students through the use of virtual environments, comprising:
developing a virtual environment adapted for implementation with a course of study and presenting various learning opportunities, said virtual environment being accessible through video game like experiences for students;
assigning at least one avatar to each of said students, each student exercising control over a uniquely associated avatar, each said student controlling said uniquely associated avatar as to navigation, movement and decision making within said virtual environment;
said students resolving issues and solving problems posed in said virtual environment; and
each said student maintaining a student portfolio containing input from said student indicating said student's progress and deficiencies as assessed by said student's actions in said steps of resolving issues and solving problems.

2. The method for educating students according to claim 1, further comprising the step of student-to-student communication through a student interface to facilitate resolving issues and solving problems.

3. The method for educating students according to claim 2, further comprising the step of student-to-teacher communication through said student interface and a teacher interface.

4. The method for educating students according to claim 3, further comprising the step of parent-to-student and parent-to-teacher communications through a parent interface, and further comprising the step of allowing controlled access of a parent to an associated student's portfolio.

5. The method for educating students according to claim 3, further comprising the step of issuing smart tools to various avatars for undertakings of data acquisition and assessment to assist in said steps of resolving issues and solving problems.

6. The method for educating students according to claim 5, further comprising the step of game design practiced by at least one of said students and teacher.

7. The method for educating students according to claim 6, further comprising the step of depositing a resulting game in a marketplace for access by others.

8. The method for educating students according to claim 5, further comprising the step of effecting changes to said virtual environment by at least one of said students and teacher.

9. The method for educating students according to claim 8, wherein said changes to said virtual environment are deposited in a marketplace for access by others.

10. The method for educating students according to claim 5, wherein a plurality of virtual environments and associated video games are maintained in a virtual learning core in communication with a plurality of satellite educational organizations.

11. The method for educating students according to claim 10, wherein at least certain of said satellite educational organizations communicate simultaneously with said virtual learning core, each of said certain satellite educational organizations engaging uniquely associated games, virtual environments, students and teachers.

12. The method for educating students according to claim 11, wherein communications between and among students, teacher, educational organizations and said virtual learning core are undertaken with devices from a group comprising personal computers, smart pads and smart phones.

13. The method for educating students according to claim 5, further comprising the step of issuing rewards to avatars for interim achievement and progress in resolving issues and solving problems.

14. An educational system employing environments, comprising:
one or more remote educational organizations, each having associated therewith one or more virtual environments;
a Virtual Learning Core in selective communication with each of said one or more remote educational organizations; and
wherein said Virtual Learning Core comprises;
a database for receiving, storing, assessing and transferring data;
an avatar tool in communication with said database for enabling teachers and students to create for themselves uniquely associated avatars for selectively engaging in activities within said virtual environments; and
student and teacher interface modulus in interconnection with said database for communication among students and a teacher within said virtual environments

15. The educational system employing virtual environments according to claim 14, further comprising game design modules in communication with said student and teacher interface modules for allowing teachers and students to generate new games for learning in the associated virtual environments.

16. The educational system employing virtual environments according to claim 15, further comprising a virtual environment change module in communication with each of said teacher and student interfaces for allowing a teacher and student to effect changes in said associated virtual environments.

17. The educational system employing virtual environments according to claim 16, further comprising a research module in communication with said teacher and student interfaces through said database, said research module making data available for assessment of individual effectiveness.

18. The educational system employing virtual environments according to claim 17, further comprising a marketplace into which students and teachers may deposit new games, virtual environment changes and other developments for retrieval and use by other students and teachers.

19. The educational system employing virtual environments according to claim 18, further comprising a parent interface operatively connected to said database and in communication with said student and teacher interfaces, providing parents access to student files and associated materials and communication with an associated teacher and student.

20. The educational system employing virtual environments according to claim 19, wherein a period of enablement of said parent interface is controlled through said teacher interface.
